(19) United States
(12) Patent Application Publication
(10) Pub. No.: US 2024/0259978 A1
(43) Pub. Date: Aug. 1, 2024

(54) METHOD AND DEVICE FOR SUPPORTING MINIMIZATION OF SERVICE DISRUPTION IN WIRELESS COMMUNICATION SYSTEM

(71) Applicant: Samsung Electronics Co., Ltd., Suwon-si, Gyeonggi-do (KR)

(72) Inventor: Kyungjoo SUH, Suwon-si (KR)

(21) Appl. No.: 18/290,410

(22) PCT Filed: May 11, 2022
(86) PCT No.: PCT/KR2022/006782

§ 371 Date: Nov. 13, 2023

(30) Foreign Application Priority Data
May 11, 2021 (KR) 10-2021-0060952

(51) Int. Cl. H04W 60/00; H04W 24/04; H04W 84/04

(52) U.S. Cl. CPC H04W 60/00; H04W 24/04; H04W 84/042

(57) ABSTRACT

The present disclosure relates to a device and an operating method of a terminal in a wireless communication system. The operating method of the terminal may include receiving, from a first access and mobility management function (AMF) corresponding to a first public land mobile network (PLMN), a first registration accept message including information related to a disaster PLMN (DPLMN), selecting a second PLMN based on the first registration accept message, transmitting, to a second AMF corresponding to the second PLMN, a registration request message in which a disaster-related indication is configured, and receiving, from the second AMF, a second registration accept message, based on the registration request message.

### TECHNICAL FIELD

The present disclosure relates to a method and a device for supporting minimization of service disruption in a wireless communication system, and is provided to prevent service disruption by providing a plan for service support through other operators even when a problem occurs with a network of an operator through which a terminal receives a service.

### BACKGROUND ART

To meet the increased demand for wireless data traffic after the commercialization of 4^{th} generation (4G) communication systems, considerable efforts have been made to develop improved 5^{th} generation (5G) communication systems or pre-5G communication systems. For this reason, 5G communication systems or pre-5G communication systems are called beyond 4G network communication systems or post long term evolution (LTE) systems. 5G communication systems defined by 3rd generation partnership project (3GPP) is called new radio (NR) systems. To achieve a high data rate, the implementation of 5G communication systems in an ultra-high frequency band (millimeter wave (mmWave) (e.g., 60 GHZ) band) is under consideration. To alleviate propagation path loss of radio waves and increase propagation distances of radio waves in a millimeter wave band, technologies for 5G communication systems, such as beamforming, massive multi-input multi-output (MIMO), full dimensional MIMO (FD-MIMO), array antenna, analog beamforming, and large-scale antenna system, are being discussed and have been applied to NR systems. Also, in order to improve a system network for 5G communication systems, technologies, such as evolved small cell, advanced small cell, cloud radio access network (cloud RAN), ultra-dense network, device-to-device (D2D) communication, wireless backhaul, moving network, cooperative communication, coordinated multi-points (COMP), and received interference cancellation, are being developed. In addition, for 5G communication systems, hybrid frequency shift keying (FSK) and quadrature amplitude modulation (QAM) (FQAM) and sliding window superposition coding (SWSC), which are advanced coding modulation (ACM) schemes, and filter bank multi-carrier (FBMC), non-orthogonal multiple access (NOMA), and sparse code multiple access (SCMA), which are advanced access technologies, have been developed.

The Internet has evolved from a human-centered connection network, through which humans generate and consume information, to an Internet of things (IoT) network that exchanges and processes information between distributed elements such as objects. An Internet of everything (IoE) technology is emerging, in which a technology related to the IoT is combined with, for example, a technology for processing big data through connection with a cloud server. In order to implement the IoT, various technical components are required, such as, a sensing technology, wired/wireless communication and network infrastructures, a service interfacing technology, a security technology, etc. In recent years, technologies including a sensor network for connecting objects, machine-to-machine (M2M) communication, machine type communication (MTC), etc., have been studied. In the IoT environment, intelligent Internet technology (IT) services may be provided to collect and interpret data obtained from objects connected to each other, and to create new value in human life. As existing information technology (IT) and various industries converge and combine with each other, the IoT may be applied to various fields, such as smart homes, smart buildings, smart cities, smart cars or connected cars, smart grids, health care, smart home appliances, high quality medical services, etc.

Various attempts are being made to apply 5G communication systems to IoT networks. For example, technologies related to sensor networks, M2M communication, MTC, etc., are implemented by using 5G communication technologies including beamforming, MIMO, array antenna, etc. The application of cloud RAN as the big data processing technology described above may be an example of convergence of 5G communication technology and IoT technology.

With those described above and the development of mobile communication systems, there is a need for a method of preventing disruption of a service provided to a terminal even when a problem occurs with a network of an operator through which the terminal receives the service.

### DISCLOSURE

### Technical Problem

This present disclosure relates to a method and a device for providing a service to a terminal in a wireless communication system when the service is at risk of being temporarily disrupted due to an occurrence of a problem such as fire, earthquake, etc. in a network of an operator that provides the service to the terminal.

### Technical Solution

According to an embodiment of the present disclosure, a device and an operating method of a terminal in a wireless communication system may be provided. The method performed by a terminal may include receiving, from a first access and mobility management function (AMF) corresponding to a first public land mobile network (PLMN), a first registration accept message including information related to a disaster PLMN (DPLMN), selecting a second PLMN based on the first registration accept message, transmitting, to a second AMF corresponding to the second PLMN, a registration request message in which a disaster-related indication is configured, and receiving, from the second AMF, a second registration accept message, based on the registration request message.

### DESCRIPTION OF DRAWINGS

FIG. 1 illustrates an embodiment of a terminal and a network environment for providing communication without service disruption when a communication network abnormality occurs in a 5th generation (5G) network, according to an embodiment of the present disclosure.

FIG. 2 is a flowchart for describing a procedure for providing communication without service disruption when a communication network abnormality occurs in a 5G network, according to an embodiment of the present disclosure.

FIG. 3 is a flowchart for describing a procedure for providing communication without service disruption when a communication network abnormality occurs in a 5G network, according to an embodiment of the present disclosure.

FIG. 4 is a flowchart for describing a procedure for providing communication without service disruption when a communication network abnormality occurs in a 5G network, according to an embodiment of the present disclosure.

FIG. 5 is a flowchart for describing a procedure for providing communication without service disruption when a communication network abnormality occurs in a 5G network, according to an embodiment of the present disclosure.

FIG. 6 is a diagram illustrating a structure of a terminal according to an embodiment of the present disclosure.

FIG. 7 is a diagram illustrating a structure of a network entity according to an embodiment of the present disclosure.

### BEST MODE

According to an embodiment of the present disclosure, an operating method of a terminal in a wireless communication system may be provided. An operating method of a terminal may include: receiving, from a first access and mobility management function (AMF) corresponding to a first public land mobile network (PLMN), a first registration accept message including information related to a disaster PLMN (DPLMN); selecting a second PLMN based on the first registration accept message; transmitting, to a second AMF corresponding to the second PLMN, a registration request message in which a disaster-related indication is configured; and receiving, from the second AMF, a second registration accept message, based on the registration request message.

The information related to the DPLMN according to an embodiment of the present disclosure may include a DPLMN list, and the DPLMN list may include information of at least one DPLMN.

The information related to the DPLMN according to an embodiment of the present disclosure may correspond to information related to the second PLMN that is usable in a disaster situation by the terminal.

The disaster-related indication according to an embodiment of the present disclosure may include information indicating that a disaster situation has occurred in the first PLMN.

The second registration accept message according to an embodiment of the present disclosure may include information related to a timer associated with duration information.

The second registration accept message according to an embodiment of the present disclosure may include duration information about a duration that allows a service to be received in the second PLMN.

The first registration accept message according to an embodiment of the present disclosure may include information related to the DPLMN in an equivalent PLMN (EPLMN) list.

According to an embodiment of the present disclosure, a terminal in a wireless communication system may be provided. The terminal may include a transceiver and at least one processor, wherein the at least one processor may be configured to: receive, from a first access and mobility management function (AMF) corresponding to a first public land mobile network (PLMN), a first registration accept message including information related to a disaster PLMN (DPLMN); select a second PLMN based on the first registration accept message; transmit, to a second AMF corresponding to the second PLMN, a registration request message in which a disaster-related indication is configured; and receive, from the second AMF, a second registration accept message, based on the registration request message.

The information related to the DPLMN according to an embodiment of the present disclosure may include a DPLMN list, and the DPLMN list may include information of at least one DPLMN.

The information related to the DPLMN according to an embodiment of the present disclosure may correspond to information related to the second PLMN that is usable in a disaster situation by the terminal.

The disaster-related indication according to an embodiment of the present disclosure may include information indicating that a disaster situation has occurred in the first PLMN.

The second registration accept message according to an embodiment of the present disclosure may include information related to a timer associated with duration information.

The second registration accept message according to an embodiment of the present disclosure may include duration information about a duration that allows a service to be received in the second PLMN.

The first registration accept message according to an embodiment of the present disclosure may include information related to the DPLMN in an equivalent PLMN (EPLMN) list.

### MODE FOR INVENTION

Hereinafter, embodiments of the present disclosure will be described in detail with reference to the accompanying drawings. In describing the embodiments, descriptions of technical contents that are well known in the technical field to which the present disclosure belongs and are not directly related to the present disclosure will be omitted. By omitting unnecessary description, the present disclosure may be described more clearly without obscuring the gist of the present disclosure.

For the same reason, some elements in the accompanying drawings are exaggerated, omitted, or schematically illustrated. Also, the size of each element does not entirely reflect the actual size. The same reference numerals are assigned to the same or corresponding elements in the drawings.

Advantages and features of the present disclosure, and methods of achieving them will be clarified with reference to embodiments described below in detail with reference to the accompanying drawings. In this regard, the embodiments of the present disclosure may have different forms and should not be construed as being limited to the descriptions set forth herein. Rather, these embodiments of the present disclosure are provided so that the present disclosure will be thorough and complete and will fully convey the concept of the embodiments of the present disclosure to those of ordinary skill in the art. The present disclosure is only defined by the scope of the claims. The same reference numerals denote the same elements throughout the specification.

It will be understood that the respective blocks of flowcharts and combinations of the flowcharts may be performed by computer program instructions.

Also, each block may represent part of a module, segment, or code that includes one or more executable instructions for executing a specified logical function(s). It should also be noted that, in some alternative implementations, the functions described in the blocks may occur out of the order noted in the drawings. For example, two blocks illustrated in succession may in fact be executed substantially concurrently, or the blocks may sometimes be executed in a reverse order, depending on the functions involved therein.

The term “ . . . er/or” as used herein refers to a software element or a hardware element such as field programmable gate array (FPGA) or application specific integrated circuit (ASIC), and the “ . . . er/or” performs certain functions. However, the term “ . . . er/or” is not limited to software or hardware. The term “ . . . er/or” may be configured in an addressable storage medium or may be configured to reproduce one or more processors. Therefore, for example, the term “ . . . er/or” includes elements, such as software elements, object-oriented software elements, class elements, and task elements, processes, functions, attributes, procedures, subroutines, segments of program code, drivers, firmware, microcodes, circuits, data, databases, data structures, tables, arrays, and variables. Functions provided in the elements and the “ . . . ers/ors” may be combined with fewer elements and “ . . . ers/ors” or may be separated into additional elements and “ . . . ers/ors.” Furthermore, the elements and the “ . . . ers/ors” may be implemented to reproduce one or more central processing units (CPUs) in the device or secure multimedia card. Also, in embodiments of the disclosure, the “ . . . er/or” may include one or more processors.

The term for identifying an access node, the term referring to network entities, the term referring to messages, the term referring to an interface between network entities, the terms referring to a variety of identification information, and the like, as used herein, are exemplified for convenience of explanation. Therefore, the present disclosure is not limited to the terms to be described below, and other terms referring to entities having an equivalent technical meaning may be used.

For convenience of explanation, the terms and names defined in the 3rd generation partnership project long term evolution (3GPP LTE) standard or the terms and names modified based thereon are used herein. However, the present disclosure is not limited by the terms and names and may be equally applied to systems conforming to other standards. The term “eNB” as used herein may be used interchangeably with the term “gNB” for convenience of explanation. That is, a base station described as eNB may represent gNB. In the present disclosure, the term “terminal” may refer to a user equipment (UE), a mobile station (MS), a mobile phone, NB-IoT devices, sensors, and various wireless communication devices.

A wireless communication system has evolved from a system providing voice-oriented services to a broadband wireless communication system providing high speed high quality packet data services of communication standards such as High Speed Packet Access (HSPA) of 3GPP, LTE or Evolved Universal Terrestrial Radio Access (E-UTRA), LTE-A, LTE-Pro, High Rate Packet Data (HRPD) of 3GPP2, Ultra Mobile Broadband (UMB), and IEEE 802.16e.

In an LTE system as a representative example of a broadband wireless communication system, an orthogonal frequency division multiplexing (OFDM) scheme is employed in a downlink (DL), and a single carrier frequency division multiple access (SC-FDMA) scheme is employed in an uplink (UL). The UL refers to a radio link through which a terminal (UE or MS) transmits data or a control signal to a base station (eNode B or BS), and the DL refers to a radio link through which a base station transmits data or a control signal to a terminal. In the multiple access scheme as described above, data or control information of each user may be identified by performing allocation and operation so that time-frequency resources for carrying data or control information for each user do not overlap each other, that is, orthogonality is established.

Future communication systems after LTE, that is, 5G communication systems have to be able to freely reflect various requirements of users and service providers. Therefore, services that satisfy various requirements at the same time have to be supported. Services considered for 5G communication systems include enhanced mobile broadband (eMBB), massive machine type communication (mMTC), and ultra reliability low latency communication (URLLC).

According to some embodiments, eMBB aims to provide a data rate that is higher than that supported by LTE, LTE-A, or LTE-Pro. For example, in 5G communication systems, eMBB has to be able to provide a peak data rate of 20 Gbps in a DL and a peak data rate of 10 Gbps in an UL in terms of a single base station. Also, the 5G communication systems have to provide a peak data rate and simultaneously provide an increased user perceived data rate of the UE. In order to satisfy such requirements, there is a need to improve various transmission and reception technologies including an improved multi-input multi-output (MIMO) transmission technology. Also, in a 2 GHz band used by current LTE, signals are transmitted using up to 20 MHz transmission bandwidth. However, 5G communication systems use a frequency bandwidth wider than 20 MHz in 3 to 6 GHz frequency bands or 6 GHz or higher frequency bands. Therefore, the data rate required by 5G communication systems may be satisfied.

At the same time, mMTC is under consideration so as to support application services such as Internet of things (IoT) in 5G communication systems. In order to efficiently provide IoT, mMTC needs to support access of a massive terminal in a cell, improve coverage of the terminal, improve battery time, and reduce costs of the terminal. Because IT is attached to various sensors and various devices to provide a communication function, IoT has to be able to support a large number of terminals (e.g., 1,000,000 terminals/km²) in a cell. Also, due to the nature of the service, the terminal supporting mMTC is likely to be located in a shaded area that is not covered by the cell, such as the basement of a building. Therefore, wider coverage than other services provided by the 5G communication systems may be required. The terminal supporting mMTC has to be configured as an inexpensive terminal, and it is difficult to frequently replace a battery of the terminal. Therefore, a very long battery life time such as 10 to 15 years may be required.

Finally, URLLC is a cellular-based wireless communication service used for a specific purpose (mission-critical). URLLC may be used for services used in remote control for robots or machinery, industrial automation, unmanned aerial vehicles, remote health care, emergency alerts, or the like. Therefore, communication provided by URLLC may have to provide very low latency (ultra-low latency) and very high reliability. For example, a service supporting URLLC has to satisfy air interface latency of less than 0.5 milliseconds and may simultaneously have a packet error rate of 10⁻⁵ or less. Therefore, for services supporting URLLC, the 5G systems may have to provide a smaller transmit time interval (TTI) than other services and simultaneously require a design matter that has to allocate a wide resource in a frequency band so as to ensure reliability of a communication link.

The above-described three services considered in 5G communication systems, that is, eMBB, URLLC, and mMTC, may be multiplexed and transmitted in a single system. In this case, different transmission and reception technologies and transmission and reception parameters may be used between services so as to satisfy different requirements of the respective services. However, mMTC, URLLC, and eMBB are only examples of different service types, and the service types to which the present disclosure is applied are not limited to the above-described examples.

Also, although embodiments of the present disclosure will be described below with reference to an LTE, LTE-A, LTE Pro, or a 5^{th} generation (5G) system (or an NR system, a next-generation mobile communication system, etc.), embodiments of the present disclosure may also be applied to other communication systems having a similar technical background or channel form. Also, the present disclosure may be applied to other communication systems through some modifications by those of ordinary skill in the art, without departing from the scope of the present disclosure.

In describing embodiments of the present disclosure in detail, the main focus is communication standards specified by the 3GPP. However, the main gist of the present disclosure may be applied to other communication systems having a similar technical background with slight modifications, without significantly departing from the scope of the disclosure. This will be possible by the determination of those of ordinary skill in the art.

In a 5G or new radio (NR) system, an access and mobility management function (AMF), which is a management entity that manages mobility for a user equipment (UE) (or a terminal), is separated from a session management function (SMF), which is an entity that manages sessions. Accordingly, unlike a 4th generation (4G) long term evolution (LTE) communication system in which a mobility management entity (MME) performs both mobility management and session management, an entity performing mobility management and an entity performing session management are separated in the 5G or NR system, and thus, a communication method and a communication management method between a UE and a network entity are changed.

For non-3GPP access, the 5G or NR system performs mobility management through the AMF via non-3GPP interworking function (N3IWF) and performs session management through the SMF. In addition, security-related information, which is an important element in mobility management, is processed through the AMF.

As described above, in the 4G LTE system, the MME is responsible for both mobility management and session management. The 5G or NR system may support a non-standalone architecture for performing communication by using the network entity of the 4G LTE system together.

According to the present disclosure, when a problem occurs with a network of an operator providing a service to a terminal in a wireless communication system and the service is at risk of being temporarily disrupted, the service may be provided to the terminal.

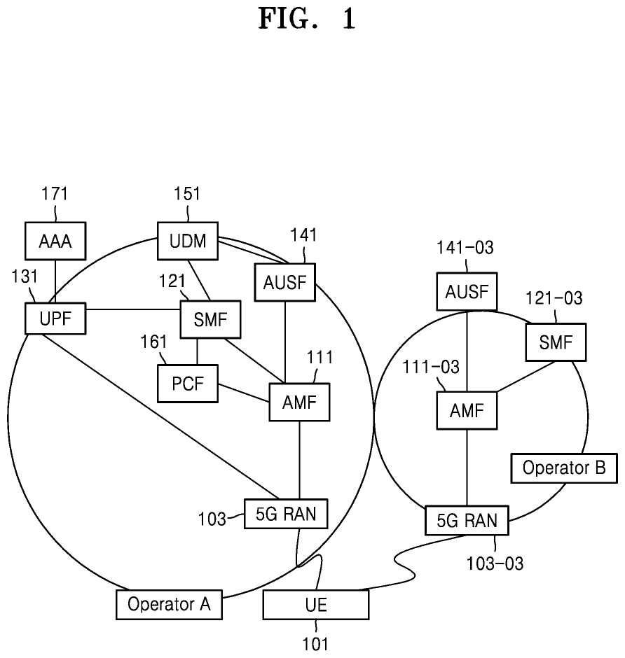

FIG. 1 illustrates an embodiment of a terminal and a network environment for providing communication without service disruption when a communication network abnormality occurs in a 5G network, according to an embodiment of the present disclosure.

Referring to FIG. 1, a 5G or NR core network may include network functions (NFs), such as a user plane function (UPF) 131, an SMF 121, an AMF 111, a 5G radio access network (RAN) 103, a user data management (UDM) 151, and a policy control function (PCF) 161. In addition, for authentication of these entities, the 5G or NR core network may include entities, such as an authentication server function (AUSF) 141 and an authentication, authorization and accounting (AAA) 171. A UE 101 may access the 5G core network through a 5G RAN (base station (BS)) 103.

On the other hand, an N3IWF may be present for a case where the UE performs communication through non-3GPP access. When the UE performs communication through non-3GPP access, the UE, the non-3GPP access, the N3IWF, and the SMF may participate in session management and control, and the UE, the non-3GPP access, the N3IWF, and the AMF may participate in mobility management and control.

In the 5G or NR system, the entities that perform mobility management and session management are respectively separated into the AMF 111 and the SMF 121. On the other hand, in the 5G or NR system, a stand-alone deployment architecture that communicates only with 5G or NR entities and a non-stand-alone deployment architecture that uses 4G entities and 5G or NR entities together may be considered.

As illustrated in FIG. 1, when the UE 101 communicates with the network, the control may be performed by the 5G RAN 103 (or eNB), and the deployment in the form of using the 5G entity of the core network may be possible. In this case, mobility management between the UE 101 and the AMF 111 and the session management between the UE 101 and the SMF 121 may be performed at a non-access stratum (NAS) layer, which is layer 3. On the other hand, access stratum (AS), which is layer 2, may be transmitted between the UE 101 and the 5G RAN 103 (or eNB). Accordingly, the UE 101 needs a method of generating and managing a security context when connected to the 5G RAN 103 and the 5G RAN 103. Accordingly, in the present disclosure, security context generation, management, and protocol exchange, which may be applied to such deployment situations, are described.

It is assumed that the communication network on which the present disclosure is based is a 5G or 4G LTE network, but the same concept may be applied to other systems within the scope that may be understood by those of ordinary skill in the art.

Referring to FIG. 1, the UE 101 is a communication service subscriber of operator A and may receive a service from operator A. The present disclosure assumes a case where the UE 101 is unable to receive a service due to a fire at the station and the communication devices of operator A or a problem in the communication network of operator A. However, in the present disclosure, a case where the UE 101 is unable to receive a communication service is not limited to the example described above. The present disclosure may provide a method of providing a communication service to the UE 101 when the UE 101 is unable to receive a communication service based on the above-mentioned reasons, etc. (i.e., when a disaster situation according to the present disclosure occurs). At this time, when a disaster situation occurs, there may be a service agreement between operator A and operator B to provide a service to a subscriber of a counterpart (i.e., operator). Alternatively, in the event of service outage, there may be an agreement or regulation between operators to enable a service based on national regulations, etc.

Referring to FIG. 1, the network of operator B may include a 5G-RAN 103-03, an AMF 111-03, an SMF 121-03, and an AUSF 141-03.

The present disclosure relates to a method and a device for preventing disruption of a service provided to the UE 101 when a problem occurs with the station, the base station 103, or the network device in the network of operator A to which the UE 101 has registered. For example, when a disaster situation occurs, a plan for service support between operator A and operator B may be prepared to support a service to the UE 101 in the form of temporary roaming. Even in a situation where a problem occurs with major communication devices such as the communication station or the base station 103 of the operator (operator A) to which the UE 101 has registered according to an embodiment of the present disclosure, a method capable of supporting the agreements between communication companies and the service disruption situation may be provided. According to the present disclosure, the interruption of service support provided to the UE 101 may be prevented, and the UE 101 may receive service support while preventing communication interruption. In addition, according to an embodiment, the present disclosure may provide a method of supporting communication by using a NAS message when service disruption occurs.

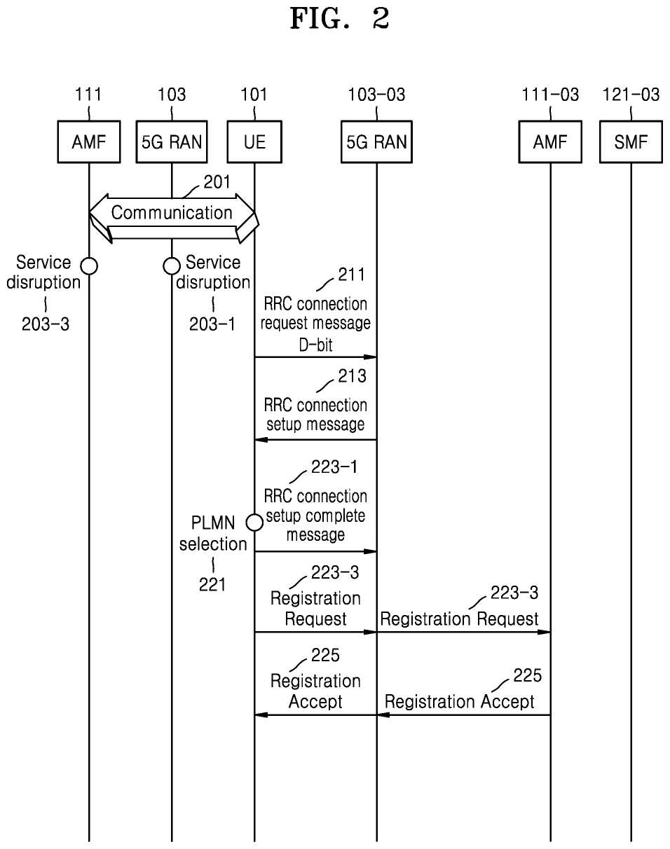

FIG. 2 is a flowchart for describing a procedure for providing communication without service disruption when a communication network abnormality occurs in a 5G network, according to an embodiment of the present disclosure.

Referring to operation 201, the UE 101 is performing communication in the network of operator A (hereinafter referred to as “A network”). The UE 101 according to another embodiment is a subscriber who has registered the network of operator A and is attempting to perform communication in the A network. Referring to operations 203-1 and 203-3, an occurrence of a situation in which, while the UE 101 is performing communication in the network of operator A, communication becomes impossible because an error occurs in the communication device of the A network of operator A, or a service disruption occurs because a problem occurs in communication, may be identified. For example, the situation in which the service disruption occurs may include a situation in which a fire occurs in a communication station, a base station, or a device, but the present disclosure is not limited thereto.

Referring to operation 211, when the problem occurs in the A network of operator A (a temporary service disruption phenomenon as described above), even when the UE 101 is not a subscriber of operator B, the UE 101 may temporarily receive a service from the network of operator B based on the agreement between operator A and operator B.

Hereinafter, when an interruption occurs in a communication network that is not a network to which the UE 101 has registered, but has an agreement with a communication company to which the UE 101 has registered, or when an interruption occurs in a communication network to which the UE 101 has registered, an operation, performed by the UE 101, of receiving a service in a communication network (e.g., a B network of operator B in the present disclosure) that is agreed or designated to allow the service by the national regulation.

Referring to operation 211, the UE 101 may transmit a radio resource control (RRC) connection request message to the 5G RAN 103-03. In operation 211, the UE 101 in an idle state may attempt an RRC connection with the 5G RAN 103-03 so as to respond to a call attempt, data transmission attempt, or paging.
Case 1) The UE 101 according to an embodiment may transmit information indicating a disaster situation by including the information in the RRC connection request message to be transmitted to the 5G RAN 103-03. As an example, the information indicating the disaster situation may be indicated by using a specific bit such as a disaster bit (e.g., D-bit in FIG. 2).
Case 2) The UE 101 according to an embodiment may transmit information indicating a disaster situation as a cause value in the RRC connection request message so as to notify a disaster situation.

In operation 213, the UE 101 may receive, from the 5G RAN 103-03, an RRC connection setup message that is a response message. As an example, when the 5G RAN 103-03 accepts the connection request of the UE 101, the UE 101 may receive the RRC connection setup message from the 5G RAN 103-03. Even when the UE 101 is not a UE 101 registered to the corresponding operator network, when the operator (e.g., operator B) to which the UE 101 attempted to connect has an agreement with the operator (e.g., operator A) to which the UE 101 has registered, or when operator B is an operator that is able to temporarily provide a service to the UE 101 due to regulations or national policies, etc., the 5G RAN 103-03 of operator B, which has received the information about the disaster situation from UE 101, may transmit the RRC connection setup message to the UE 101 having attempted to connect to 5G by using the information about the disaster situation.

In operation 221, the UE 101 may perform the following procedure in relation to public land mobile network (PLMN) selection. For example, the PLMN may be identified by a mobile country code (MCC) and a mobile network code (MNC).

PLMN information of the cell may be broadcast by being included in system information.

When the UE 101 is initially powered on, the UE 101 may search for an available PLMN and select an appropriate PLMN capable of receiving a service. The NAS layer of the UE 101 may notify the AS layer that PLMN selection is necessary. The AS layer may search for the corresponding band and notify a PLMN list to the NAS layer.

The NAS layer of the UE 101 may select the PLMN for registering the UE 101 according to the priority order of PLMN/radio access technology (RAT) selection stored in a user services identity module (USIM).

The UE 101 may search for a suitable cell among cells to which the PLMN will belong, and may select a cell capable of providing an appropriate service. The suitable cell according to an embodiment of the present disclosure may refer to a cell that allows the UE 101 to receive a suitable service, and the corresponding cell has to be an acceptable cell which belongs to a PLMN that is accessible by the UE 101 and in which the UE 101 is not barred from performing a registration procedure. In addition, when the corresponding cell is a closed access group (CAG) cell, the UE 101 may be a CAG member and the corresponding cell has to be a cell that is accessible by the UE 101.

As an example, a cell that allows the UE 101 to receive a limited service is referred to as an acceptable cell. The acceptable cell may refer to a cell in which the UE 101 is not barred from camping on the acceptable cell and which satisfies the cell selection criterion of the UE 101. That is, the acceptable cell may be a cell in which signal strength or signal quality is satisfied. The case where the UE 101 receives the limited service may be the case of receiving services related to an emergency call or an earthquake and tsunami warning system (ETWS), and the limited service described above may be provided in the acceptable cell.

### Case 1)

The following is an automatic PLMN selection method, and the priority order of the PLMN selection method is as follows.

In an embodiment, the UE 101 may select the PLMN in the following order.
1) Registered PLMN (RPLMN), equivalent PLMN (EPLMN-PLMN), or disaster PLMN (DPLMN)

In the present disclosure, the DPLMN may be a PLMN that allows the UE 101 to access or register to receive a service in a disaster situation. When the UE 101 is successful in registering with a home PLMN (HPLMN), information about the DPLMN may be transmitted from the AMF to the UE 101 by being included in a registration accept message.
Embodiment 1-1) According to an embodiment, DPLMN information may be transmitted by being included in the DPLMN list of the registration accept message.
Embodiment 1-2) According to an embodiment, DPLMN information may be transmitted by being included in the EPLMN list of the registration accept message. In other words, Case 1-2) described above is a case where a PLMN that is registerable by the UE 101 in a disaster situation (i.e., a DPLMN that is a PLMN registerable in a disaster situation) is transmitted from the AMF to the UE 101 by using a list (i.e., information element) that transmits the EPLMN.
2) User controlled PLMN and access technology
3) Operator controlled PLMN and access technology
4) PLMN reported as high quality PLMN by AS layer

### Case 2)

The following is an automatic PLMN selection method, and the priority order of the PLMN selection method is as follows.

In an embodiment, the UE 101 may select the PLMN in the following order.
1) RPLMN or EPLMN
2) User controlled PLMN and access technology
3) Operator controlled PLMN and access technology

The operator controlled PLMN may refer to information that the operator provides to the UE 101 (hereinafter, operator controlled PLMN or operator controlled PLMN list). The operator controlled PLMN may be information about the PLMN configured in the USIM by the operator.

According to an embodiment of the present disclosure, DPLMN information that is usable in a disaster situation may be provided to the operator controlled PLMN.
Embodiment 3-1) According to an embodiment, DPLMN information may be configured in the UE 101 in the form that is pre-configured in the operator controlled PLMN list and is stored in the USIM.
Embodiment 3-2) In an embodiment, the AMF may configure DPLMN information for the UE 101, and the DPLMN information may be stored in the operator controlled PLMN list. The embodiment may be a method of allowing the UE 101 to select the PLMN from the operator controlled PLMN based on the priority for selecting the PLMN.

In the present disclosure, the DPLMN may be a PLMN that allows the UE 101 to access or register to receive a service in a disaster situation. When the UE 101 is successful in registering with the HPLMN, the DPLMN may be transmitted from the AMF to the UE 101 by being included in the registration accept message.
Embodiment 3-2-1) The DPLMN according to an embodiment may be transmitted by being included in the DPLMN list of the registration accept message. The UE 101 that has received the registration accept message may store the DPLMN list in the operator controlled PLMN.
Embodiment 3-2-2) The DPLMN according to an embodiment may be transmitted by being included in the registration accept message. In other words, this case may be a case where a PLMN that is registerable by the UE 101 in a disaster situation (i.e., a DPLMN that is a PLMN registerable in a disaster situation) is transmitted from the AMF to the UE 101 by using an information element. When the UE 101 receives the corresponding information, the UE 101 may store the received information in the operator controlled PLMN.
4) PLMN reported as high quality PLMN by AS layer

### Case 3)

The following is an automatic PLMN selection method, and the priority order of the PLMN selection method is as follows.

In an embodiment, the UE 101 may select the PLMN in the following order.
1) RPLMN or EPLMN
2) User controlled PLMN and access technology
3) Operator controlled PLMN and access technology
4) PLMN reported as high quality PLMN by AS layer

According to an embodiment, in a case where there is a PLMN with an agreement of an operator among PLMNs reported as a high quality PLMN by an AS layer, there may be a method of processing the PLMN as a DPLMN.
Embodiment 4-1) According to an embodiment, DPLMN information may be configured in the UE 101 in the form that is pre-configured in the PLMN list in a disaster situation and is stored in the USIM.

Example 4-2) In a case where there is a PLMN with an agreement of an operator among high quality PLMNs that satisfy at least one of signal strength or signal quality, when the UE 101 is allowed to access the corresponding PLMN, there may be a method of storing the DPLMN information in the DPLMN list. In the present disclosure, the DPLMN may be a PLMN that allows the UE 101 to access or register to receive a service in a disaster situation.

### Case 4)

As another method, there is a manual PLMN selection method. The manual PLMN selection method may be a method by which the user selects one PLMN from the PLMN list provided by the AS layer of the UE 101.

In an embodiment, when the UE 101 successfully completes location registration, the selected PLMN may be a RPLMN, and the RPLMN may be a PLMN in which location registration has been successfully completed. In an embodiment, an EPLMN may be a PLMN treated as equivalent to the RPLMN. In addition, a visited PLMN (VPLMN) may refer to a PLMN when the UE 101 is in a roaming state and a service is provided to the UE 101.

Operations 223-1 and 223-3 are described below. A message transmitted in operation 223-1 may be an RRC message between the UE 101 and the 5G RAN 103-03. According to an embodiment, a NAS message of operation 223-3 may be carried in the RRC message transmitted in operation 223-1.

The NAS message of operation 223-3 may be transmitted from the UE 101 to the AMF in a section between the UE 101 and the AMF.

In operation 223-1, the UE 101 may transmit an RRC connection setup complete message to the 5G RAN 103-03, and the UE 101 may transition to a RRC connection mode.

According to an embodiment, the registration request message, which is a type of NAS message, may be carried in the RRC message (e.g., the RRC connection setup complete message) transmitted in operation 223-1. Alternatively, the registration request message, which is a type of NAS message, may be included in the RRC message. Alternatively, the registration request message, which is a type of NAS message, may be piggybacked or concatenated and carried in the RRC message.

In operation 223-3, the UE 101 may transmit the registration request message to the AMF. At this time, a disaster indication may be transmitted by being configured in the registration request message so as to notify of a disaster situation.

In operation 225, the AMF may transmit a registration accept message to the UE 101. At this time, in an embodiment, because the registration accept message transmitted from the AMF to the UE 101 is temporarily registered with the corresponding operator network by the UE 101, a duration during which the UE 101 is able to receive a service from the corresponding operator network may be configured. In the case of the UE 101 that the AMF allows to temporarily register in a disaster situation, the AMF may transmit the registration accept message by configuring a timer for the service duration during the duration for which the service is allowed to the UE 101 in the registration accept message transmitted from the AMF to the UE 101.

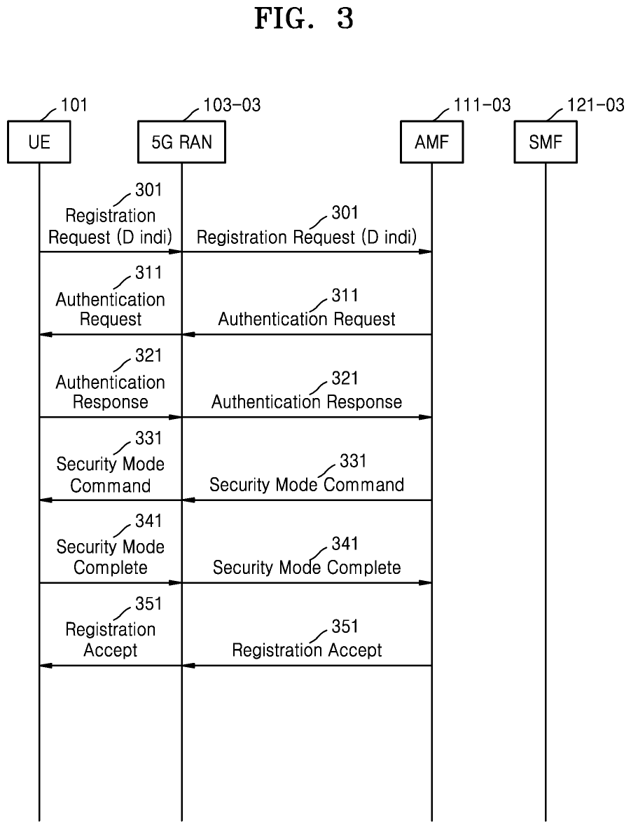

FIG. 3 is a flowchart for describing a procedure for providing communication without service disruption when a communication network abnormality occurs in a 5G network, according to an embodiment of the present disclosure.

In operation 301, the UE 101 may transmit the registration request message to the AMF. As an example, the registration request message may be transmitted with a disaster indication (e.g., D indi in FIG. 3) configured so as to notify of a disaster situation.

After that, the AMF may generate a temporary security key that is usable in the disaster situation.

In operation 311, the AMF may transmit an authentication request message to the UE 101.
Case 1) At this time, in an embodiment, the AMF may transmit a temporary key seed so as to allow the UE 101 to generate a temporary key. The UE 101 that has received the temporary key seed may generate a security key based on the temporary key seed.
Case 2) In another embodiment, the AMF may transmit, to the UE 101, an indication for generating the temporary key notified so as to generate the temporary key. The UE 101 that has received the indication for generating the temporary key may generate the temporary key.

In operation 321, the UE 101 may transmit an authentication response message to the AMF.

In operation 331, the AMF may transmit a security mode command message to the UE 101.

In operation 341, the UE 101 may transmit a security mode complete message to the AMF.

In operation 351, the AMF may transmit a registration accept message to the UE 101. At this time, in an embodiment, Case 1) because the UE 101 is temporarily registered in the corresponding operator network, the registration accept message transmitted from the AMF to the UE may have a configuring of a duration during which the UE 101 is able to receive a service from the corresponding operator network. In the case of the UE 101 that the AMF allows to temporarily register in a disaster situation, the registration accept message may be transmitted by setting a timer for the service duration during the duration for which the service is allowed to the UE 101 in the registration accept message transmitted from the AMF to the UE 101.

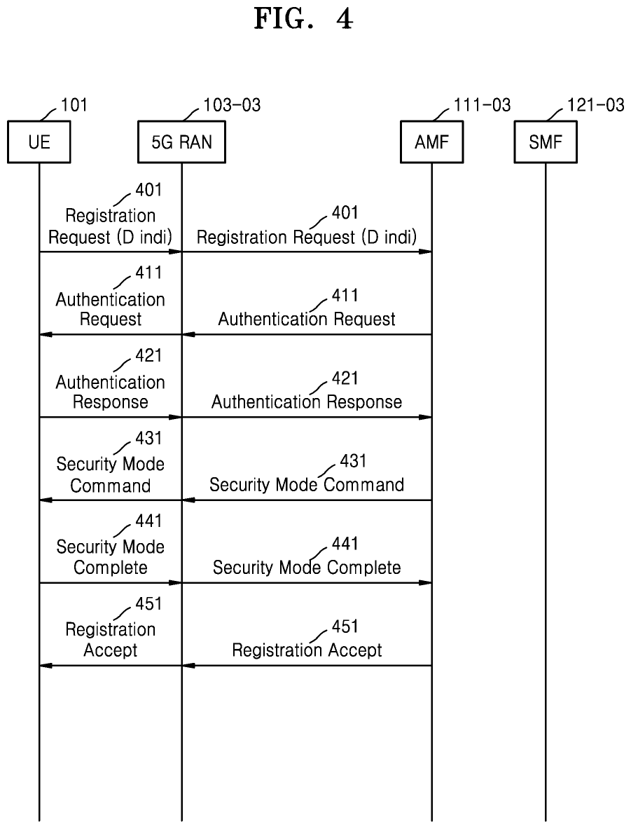

FIG. 4 is a flowchart for describing a procedure for providing communication without service disruption when a communication network abnormality occurs in a 5G network, according to an embodiment of the present disclosure.

In operation 401, the UE 101 may transmit the registration request message to the AMF. According to an embodiment, a disaster indication may be transmitted by being configured in the registration request message so as to notify of a disaster situation.

After that, the AMF may generate a temporary security key that is usable in a disaster situation.

In operation 411, the AMF may transmit an authentication request message to the UE 101.
Case 1) In an embodiment, the AMF may transmit a temporary key seed so as to allow the UE 101 to generate a temporary key. The UE 101 that has received the temporary key seed may generate a security key based on the temporary key seed.
Case 2) In another embodiment, the AMF may transmit, to the UE 101, an indication for generating the temporary key notified so as to generate the temporary key. The UE 101 that has received the indication for generating the temporary key may generate the temporary key.

In operation 421, the UE 101 may transmit an authentication response message to the AMF.

In operation 431, the AMF may transmit a security mode command message to the UE 101. At this time, in an embodiment, the AMF may notify the UE 101 to use at least one of a null encryption algorithm or a null integrity protection algorithm.

In operation 441, the UE 101 may transmit a security mode complete message to the AMF.

In operation 451, the AMF may transmit a registration accept message to the UE 101. At this time, in an embodiment, because the registration accept message transmitted from the AMF to the UE 101 is temporarily registered with the corresponding operator network by the UE 101, a duration during which the UE 101 is able to receive a service from the corresponding operator network may be configured. In the case of the UE 101 that the AMF allows to temporarily register in a disaster situation, the registration accept message may be transmitted by configuring a timer for the service duration during the duration for which the service is allowed to the UE 101 in the registration accept message transmitted from the AMF to the UE 101.

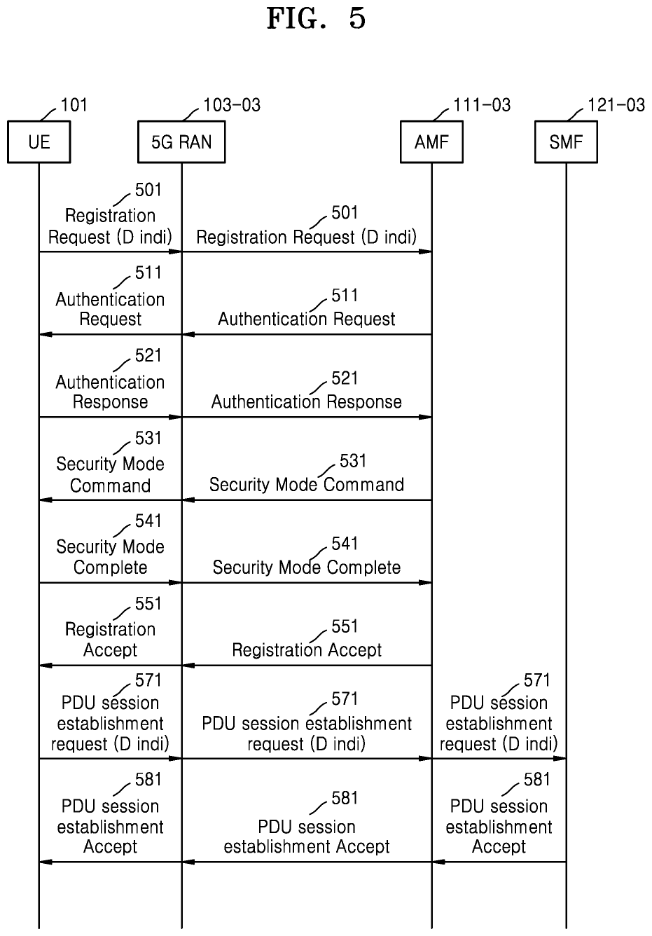

FIG. 5 is a flowchart for describing a procedure for providing communication without service disruption when a communication network abnormality occurs in a 5G network, according to an embodiment of the present disclosure.

In operation 501, the UE 101 may transmit a registration request message to the AMF. According to an embodiment, the registration request message may be transmitted with a disaster indication (e.g., D indi in FIG. 5) configured so as to notify of a disaster situation.

After that, the AMF may generate a temporary security key that is usable in a disaster situation.

In operation 511, the AMF may transmit an authentication request message to the UE 101.
Case 1) In an embodiment, the AMF may transmit a temporary key seed so as to allow the UE 101 to generate a temporary key. The UE 101 that has received the temporary key seed may generate a security key based on the temporary key seed.
Case 2) In another embodiment, the AMF may transmit, to the UE 101, an indication for generating the temporary key notified so as to generate the temporary key. The UE 101 that has received the indication for generating the temporary key may generate the temporary key.

In operation 521, the UE 101 may transmit an authentication response message to the AMF.

In operation 531, the AMF may transmit a security mode command message to the UE 101. According to an embodiment, the AMF may notify the UE 101 to use at least one of a null encryption algorithm or a null integrity protection algorithm.

In operation 541, the UE 101 may transmit a security mode complete message to the AMF.

In operation 551, the AMF may transmit a registration accept message to the UE 101.

At this time, in an embodiment, because the registration accept message transmitted from the AMF to the UE 101 is temporarily registered with the corresponding operator network by the UE 101, a duration during which the UE 101 is able to receive a service from the corresponding operator network may be configured. In the case of the UE 101 that the AMF allows to temporarily register in a disaster situation, the registration accept message may be transmitted by setting a timer for the service duration during the duration for which the service is allowed to the UE 101 in the registration accept message transmitted from the AMF to the UE 101.

In operation 571, the UE 101 may transmit a packet data unit (PDU) session establishment request message to the SMF. As an example, the PDU session establishment request message may include an indication indicating a disaster situation so as to notify of a disaster situation.

In operation 581, the SMF 121-03 may transmit a PDU session establishment accept message to the UE 101.

In an embodiment of the present disclosure, in operation 581, when the SMF 121-03 transmits a PDU session establishment accept message to the UE 101, the SMF 121-03 may limit the number of PDU sessions of the UE 101. The embodiment illustrated in FIG. 5 is a situation in which, although the UE 101 is not a normal subscriber to the network of the operator (that is, the UE 101 is a terminal that has registered a network of another operator), communication is possible for the UE 101 due to a disaster situation that has occurred in the network of the other operator. Communication may be permitted to the UE 101 according to rules established by regulations or agreements between operators. However, in order to prevent service disruption caused by disaster situations of other operators, services are provided to the corresponding UEs. As an example, when the SMF 121-03 performs PDU session establishment for the UE 101, the SMF 121-03 may limit the number of PDU sessions allowed to the UE 101. For example, in a normal situation, the UE 101 may set up to 15 PDU sessions. However, according to the present disclosure, in the case of resolving a disaster situation occurring in the network of another operator, the number of PDU sessions may be limited to 1 or 2. In order to notify that there is a limitation to PDU session establishment, the SMF 121-03 according to an embodiment may transmit, to the UE 101, an indication indicating that there is a limitation to the PDU session.

In an embodiment of the present disclosure, in operation 581, when the SMF 121-03 transmits a PDU session establishment accept message to the UE 101, the SMF 121-03 may set a timer that allows the PDU session to be durable (e.g., PDU session duration timer), or may transmit the PDU session establishment accept message by setting a PDU session duration timer value. Because the PDU session duration timer means that the UE 101 temporarily receives a service from the corresponding operator, this is to notify that there is a time limit on the established PDU session. The PDU session duration timer may be a timer value set by the SMF 121-03 and transmitted to the UE 101. Case 1, Case 2, and Case 3 below are embodiments of a method of configuring a PDU session duration timer, according to an embodiment of the present disclosure.
Case 1) As an example, when the PDU session duration timer is configured, the corresponding PDU session may be maintained during the configured PDU session duration timer. In Case 1, the PDU session can be maintained at the value configured by the network. As an example, the network may operate the timer and the network may manage the duration of the corresponding PDU session.
Case 2) As another example, the UE 101 may receive the PDU session duration timer value through the PDU session establishment accept message, and the UE 101 may maintain the corresponding PDU session during the corresponding PDU session duration timer value. In Case 2, the network may notify the UE 101 of the PDU session duration timer, and the UE 101 may operate the timer according to the value notified by the PDU session duration timer. As an example, the network may notify the timer value and the UE 101 may operate the timer.
Case 3) As another example, when the network notifies the PDU session duration timer, the network (e.g., the SMF 121-03) and the UE 101 may maintain the corresponding PDU session during the set PDU session duration timer. In Case 3, the PDU session can be maintained at the value configured by the network. In addition, in Case, the network may operate the timer and the UE may also operate the timer.

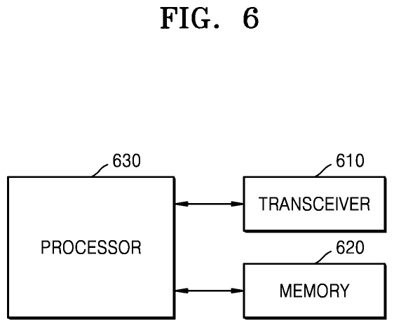

FIG. 6 is a diagram illustrating a structure of a terminal according to an embodiment of the present disclosure.

As illustrated FIG. 6, the terminal according to an embodiment of the present disclosure may include a transceiver 610, a memory 620, and a processor 630. The processor 630, the transceiver 610, and the memory 620 of the terminal may operate according to the communication method of the terminal described above. However, the elements of the terminal are not limited to the example described above. For example, the terminal may include more elements than the elements described above, or may include fewer elements than the elements described above. In addition, the processor 630, the transceiver 610, and the memory 620 may be implemented in the form of a single chip.

The transceiver 610 collectively refers to a receiver of the terminal and a transmitter of the terminal, and may transmit and receive signals to and from a base station or a network entity. The signals, which are transmitted and received to and from the base station, may include control information and data. To this end, the transceiver 610 may include an RF transmitter that performs up-conversion and amplification on a frequency of a signal to be transmitted, and an RF receiver that performs low noise amplification on a received signal and performs down-conversion on the received signal. However, this is only an embodiment of the transceiver 610, and the elements of the transceiver 610 are not limited to the RF transmitter and the RF receiver.

In addition, the transceiver 610 may include a wired/wireless transceiver, and may include various elements configured to transmit and receive signals.

In addition, the transceiver 610 may receive a signal through a radio channel, output the received signal to the processor 630, and transmit an output signal of the processor 630 through the radio channel.

Moreover, the transceiver 610 may receive a communication signal, output the received communication signal to the processor, and transmit an output signal of the processor to the network entity through a wired/wireless network.

The memory 620 may store programs and data required for the operation of the UE. In addition, the memory 620 may store control information or data included in the signals obtained by the terminal. The memory 620 may include a storage medium, such as read-only memory (ROM), random access memory (RAM), hard disk, compact disc-ROM (CD-ROM), and digital versatile disc (DVD), or any combination thereof.

The processor 630 may control a series of processes so that the terminal is able to operate according to the above-described embodiments of the present disclosure. The processor 630 may include least one or more processors. For example, the processor 630 may include a communication processor (CP) that performs control for communication, and an application processor (AP) that controls an upper layer such as an application program.

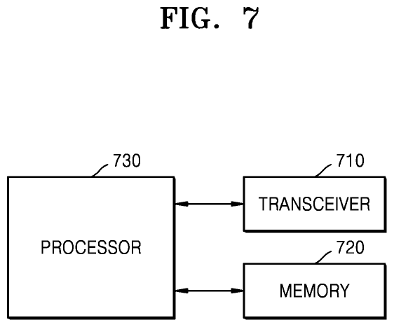

FIG. 7 is a diagram illustrating a structure of a network entity according to an embodiment of the present disclosure.

As illustrated FIG. 7, the network entity according to an embodiment of the present disclosure may include a transceiver 710, a memory 720, and a processor 730. The processor 730, the transceiver 710, and the memory 720 of the network entity may operate according to the communication method of the network entity described above. However, the elements of the network entity are not limited to the example described above. For example, the network entity may include more elements than the elements described above, or may include fewer elements than the elements described above. In addition, the processor 730, the transceiver 710, and the memory 720 may be implemented in the form of a single chip.

The network entity may include the above-described NFs, such as the AMF, the SMF, the PCF, network exposure function (NEF), the UDM, and the UPF. In addition, the network entity may include a base station.

The transceiver 710 collectively refers to a receiver of the network entity and a transmitter of the network entity, and may deliver and receive signals to and from a terminal or other network entities. The signals, which are delivered and received to and from the terminal or other network entities, may include control information and data. To this end, the transceiver 710 may include an RF transmitter that performs up-conversion and amplification on a frequency of a signal to be delivered, and an RF receiver that performs low noise amplification on a received signal and performs down-conversion on the received signal. However, this is only an embodiment of the transceiver 710, and the elements of the transceiver 710 are not limited to the RF transmitter and the RF receiver. The transceiver 710 may include a wired/wireless transceiver, and may include various elements configured to deliver and receive signals.

In addition, the transceiver 710 may receive a signal through a communication channel (e.g., a radio channel), output the received signal to the processor 730, and deliver an output signal of the processor 730 through the communication channel.

Moreover, the transceiver 710 may receive a communication signal, output the received communication signal to the processor 830, and deliver an output signal of the processor 830 to the terminal or the network entity through a wired/wireless network.

The memory 720 may store programs and data required for the operation of the network entity. In addition, the memory 720 may store control information or data included in signals obtained by the network entity. The memory 720 may include a storage medium, such as read-only memory (ROM), random access memory (RAM), hard disk, compact disc-ROM (CD-ROM), and digital versatile disc (DVD), or any combination thereof.

The processor 730 may control a series of processes so that the network entity is able to operate according to the above-described embodiments of the disclosure. The processor 730 may include least one or more processors. The methods according to the embodiments of the present disclosure, which are described in the claims or the detailed description, may be implemented as hardware, software, or a combination of hardware and software.

When implemented as software, a computer-readable storage medium storing one or more programs (software modules) may be provided. One or more programs stored in the computer-readable storage medium are configured to be executable by one or more processors in an electronic device. One or more programs include instructions that cause the electronic device to execute the methods according to the embodiments of the disclosure, which are described in the claims or the specification of the disclosure.

One or more programs (software modules, software, etc.) may be stored in RAM, non-volatile memory including flash memory, ROM, electrically erasable programmable read-only memory (EEPROM), magnetic disc storage devices, CD-ROM, DVDs, other types of optical storage devices, or magnetic cassettes. Alternatively, one or more programs may be stored in a memory provided by a combination of all or part of these devices. In addition, each memory may include a plurality of configured memories.

Furthermore, the programs may be stored in an attachable storage device that is accessible through a communication network, such as Internet, Intranet, local area network (LAN), wide area network (WAN), or storage area network (SAN), or a communication network provided by a combination thereof. These storage devices may be connected through an external port to a device that performs the embodiments of the disclosure. Moreover, a separate storage device on the communication network may access the device that performs the embodiment of the disclosure.

In specific embodiments of the disclosure, the elements included in the disclosure have been expressed in the singular or plural form according to the suggested specific embodiments of the disclosure. However, the expression in the singular or plural form is appropriately selected according to the suggested situations for convenience of explanation and is not intended to limit the disclosure to the single or plural elements. Even when a certain element is expressed in the plural form, it may be provided with a single element, and even when a certain element is expressed in the singular form, it may be provided with a plurality of elements.

On the other hand, although specific embodiments have been described in the detailed description of the disclosure, various modifications may be made thereto without departing from the scope of the disclosure. Therefore, the scope of the disclosure should not be limited to the described embodiments and should be defined by the following claims and the equivalents thereto.

1. A method performed by a terminal, the method comprising:
receiving, from a first access and mobility management function (AMF) corresponding to a first public land mobile network (PLMN), a first registration accept message including information related to a disaster PLMN (DPLMN);
selecting a second PLMN, based on the first registration accept message;
transmitting, to a second AMF corresponding to the second PLMN, a registration request message in which a disaster-related indication is configured; and
receiving, from the second AMF, a second registration accept message, based on the registration request message.

2. The method of claim 1,
wherein the information related to the DPLMN includes a DPLMN list, and
wherein the DPLMN list includes information of at least one DPLMN.

3. The method of claim 1, wherein the information related to the DPLMN corresponds to information related to the second PLMN that is usable in a disaster situation by the terminal.

4. The method of claim 1, wherein the disaster-related indication includes information indicating that a disaster situation has occurred in the first PLMN.

5. The method of claim 1, wherein the second registration accept message includes information related to a timer associated with duration information.

6. The method of claim 1, wherein the second registration accept message includes duration information about a duration that allows a service to be received in the second PLMN.

7. The method of claim 1, wherein the first registration accept message includes information related to the DPLMN in an equivalent PLMN (EPLMN) list.

8. A terminal comprising:
a transceiver; and
at least one processor,
wherein the at least one processor is configured to:
receive, from a first access and mobility management function (AMF) corresponding to a first public land mobile network (PLMN), a first registration accept message including information related to a disaster PLMN (DPLMN),
select a second PLMN based on the first registration accept message,
transmit, to a second AMF corresponding to the second PLMN, a registration request message in which a disaster-related indication is configured, and
receive, from the second AMF, a second registration accept message based on the registration request message.

9. The terminal of claim 8,
wherein the information related to the DPLMN includes a DPLMN list, and
wherein the DPLMN list includes information of at least one DPLMN.

10. The terminal of claim 8, wherein the information related to the DPLMN corresponds to information related to the second PLMN that is usable in a disaster situation by the terminal.

11. The terminal of claim 8, wherein the disaster-related indication includes information indicating that a disaster situation has occurred in the first PLMN.

12. The terminal of claim 8, wherein the second registration accept message includes information related to a timer associated with duration information.

13. The terminal of claim 8, wherein the second registration accept message includes duration information about a duration that allows a service to be received in the second PLMN.

14. The terminal of claim 8, wherein the first registration accept message includes information related to the DPLMN in an equivalent PLMN (EPLMN) list.
